(19) United States
(12) Patent Application Publication
(10) Pub. No.: US 2007/0073902 A1
(43) Pub. Date: Mar. 29, 2007

(54) Information processor, information processing method and program

(75) Inventors: Seiji Miyahara, Tokyo (JP); Isamu Hattori, Tokyo (JP)

Correspondence Address: ARENT FOX PLLC, 1050 CONNECTICUT AVENUE, N.W., SUITE 400, WASHINGTON, DC, 20036, US

(73) Assignee: NS SOLUTIONS CORPORATION

(21) Appl. No.: 11/527,411

(22) Filed: Sep. 27, 2006

(30) Foreign Application Priority Data
Sep. 27, 2005 (JP) 2005-280683
Sep. 8, 2006 (JP) 2006-244607

(51) Int. Cl. G06F 15/173

(52) U.S. Cl. 709/246; 709/224

(57) ABSTRACT

After an event processing that an application program corresponding to a first event request information should execute is executed with respect to at least one of window objects and variables which should be contained in the application program applicable to a first event request from a client PC, a Web server maintains the window object and variable, which are after the event processing, into a Web session and, at the same time, transmits the window object after the event processing to the client PC. Further, when the Web server further receives a second event request applicable to the same application program, the Web server executes an event processing corresponding to the second event request using the window object and variable stored in the Web session.

### CROSS-REFERENCE TO RELATED APPLICATIONS

This application is based upon and claims the benefit of priority from the prior Japanese Patent Application Nos. 2005-280683, filed on Sep. 27, 2006, and 2006-244607, filed on Sep. 8, 2006, the entire contents of which are incorporated herein by reference.

### BACKGROUND OF THE INVENTION

1. Field of the Invention

The present invention relates to an information processor, an information processing method and a program capable of applying a Web application thereto.

2. Description of the Related Art

With Visual Basic for Applications and the like, a conventional client/server system is enabled to build a client application having a graphical user interface that can realize an application with high representational power such as multiwindowing.

The client application is assumed to reside in a memory of a client terminal to request/respond to an user one to one, allowing realizing an application with superior usability with ease by automating, with a run-time, functions such as of (1) storing the state of a program (storage of the states of a global variable, an object in use and the like), (2) storing the states of plural windows (storage of the states of the windows such as displayed or nondisplayed, focused or unfocused, acceptable or unacceptable an item-input, storage of item data, and the like), (3) managing application lifecycle (management of initialization or deleting timing of the global variable and the object, management of initialization or deleting timing of the window, comprehensive management of the application such as dead or alive of the application) and (4) managing events (management of the events to occur in a GUI component and functions and methods to call as a result thereof including internal events related to the lifecycle in (3)).

Meanwhile, in the client/server system, when the number of the client terminals increases, there arise problems of requiring larger works and manpower for distributing the client application in view of installation, configuration and the like as well as larger costs for their operation.

In recent years, many Web applications adopting HTML and a Web browser have been developed, allowing a client machine to download a HTML file from a Web server from anywhere in the Internet or an intranet as long as the client machine has a Web browser installed, so that the distribution is eased.

However, the HTML file is written by a language conceived to mark up texts and is not sufficient to realize free window behavior such as multiwindowing as a client application. In addition, so as not to overweight the network, Web-based systems are composed to communicate based on a protocol called HTTP in a manner that a Web server responds when received a request from a client and then the communication is cut, in which the client and the server are not connected at all times.

Further, in a document, Tanaka, “The latest situation of Rich client (Rich client no Saishin Jijo (in Japanese)”, Java World, Vol. 8 and Vol. 9 (No. 88), 82-93 p., IDC Japan, Inc, September 2004. (nonpatent document 1), as a solution to solve problems such as in representational power, operationality and the like of a general Web application, one referred to as a rich client is disclosed.

However, in the Web application programs, it is generally difficult to realize an application using many GUIs as can be seen in the client/server systems. The reason largely depends on the difference between the architectures of the client application and the Web application. As previously described, under the architecture in which an application is generated when a request is received and the application is deleted when a response is made as in a general Web application, it is basically difficult using individual applications to (1) maintain a program state, (2) maintain multiple-window states, and (3) manage an application lifecycle. Additionally, as for (4) event management, the state is assumed to be stored, and further, an event occurring as a Web application is totally different from an event occurring in the conventional client application.

Furthermore, in the case of the rich client disclosed in nonpatent document 1, an application program operating on the client side is required. However, the development method and development environment for the application have not been prepared yet at present, where productivity, development costs increase, lack of developers and so forth can be cited as problems to be solved.

### SUMMARY OF THE INVENTION

An object of the present invention is, therefore, to realize a function of a GUI application, which has been provided by a conventional client application, by a Web application while a function corresponding, for example, to a program state storage function of the conventional client application can be performed.

Further, another object of the present invention is to enable a screen control, such as display/nondisplay of screens and focus control of the screens for plural windows, on a Web browser installed in an external device to be performed from an information processor side.

Further, still another object of the present invention is to make a conventionally-used client application and the like be usable as an event processing unit without changing the structure thereof.

An information processor according to the present invention is an information processor connected to an external device via a communication line, comprising: a receiving unit receiving event request information from the external device; an event processing unit executing an event processing which should be executed by an application program corresponding to a first event request information received by the receiving unit with respect to at least one window object and a variable which should be contained in the application program applicable to the first event request information; a storage unit storing the window object and the variable after the event processing performed by the event processing unit in a recording medium; and a transmission unit transmitting the window object after the event processing performed by the event processing unit to the external device; in which the event processing unit executes an event processing corresponding to a second event request information using the window object and the variable stored in the recording medium when the receiving unit further receives the second event request information applicable to the application program.

An information processing method according to the present invention is an information processing method by an information processor connected to an external device via a communication line, comprising: a step of receiving event request information from the external device; an event processing step executing an event processing which should be executed by an application program corresponding to a first event request information received by the receiving unit with respect to at least one window object and a variable which should be contained in the application program applicable to the first event request information; a storing step storing the window object and the variable after the event processing performed by the event processing unit in a recording medium; and a transmitting step transmitting the window object after the event processing performed by the event processing unit to the external device; in which the event processing step executes an event processing corresponding to a second event request information using the window object and the variable stored in the recording medium when the receiving unit further receives the second request information applicable to the application program.

A program product according to the present invention causes a computer to execute the information processing method.

### BRIEF DESCRIPTION OF THE DRAWINGS

FIG. 1 is a view schematically showing a structure of a Web application system according to an embodiment of the present invention;

FIG. 2 is a view showing a hardware structure of a Web server;

FIG. 3 is a view showing a functional structure of the Web server;

FIG. 4 is a flowchart showing a processing operation of a GUI processing section;

FIG. 5 is a flowchart showing an operation of an architecture conversion section;

FIG. 6 is a flowchart showing the processing operation of the GUI processing section;

FIG. 7-1 is a view schematically showing a stored state of data in a Web session;

FIG. 7-2 is a view schematically showing the stored state of the data in the Web session; and

FIG. 7-3 is a view schematically showing the stored state of the data in the Web session.

### DETAILED DESCRIPTION OF THE PREFERRED EMBODIMENTS

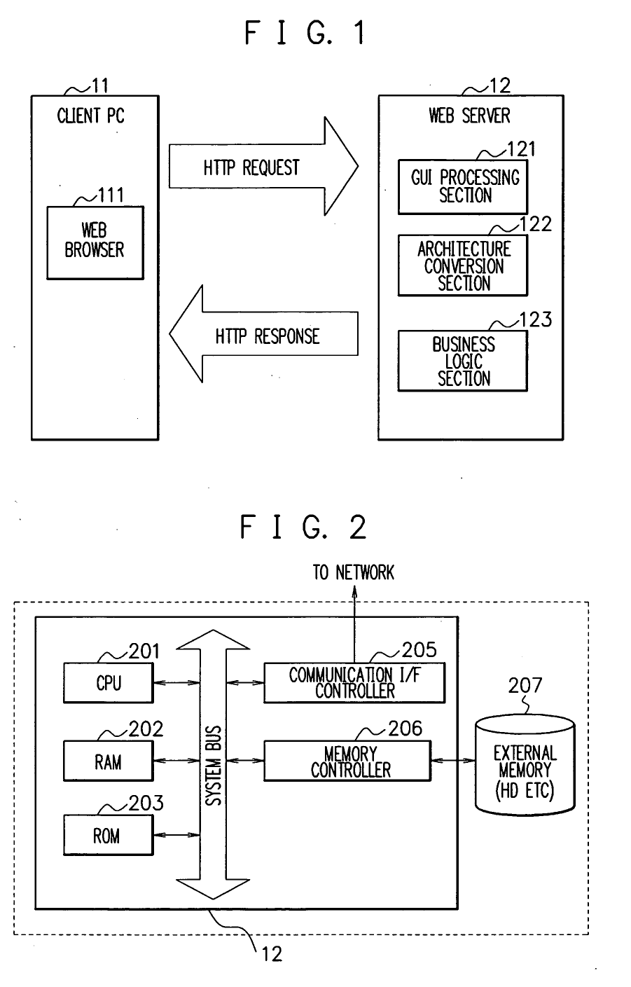

FIG. 1 is a view schematically showing a structure of a Web application system according to an embodiment of the present invention. A client PC 11 is composed, for example, of a general PC or the like, and is capable of requesting a processing to a Web server 12 by a HTTP request in compliance with HTTP and receiving a HTTP response being the response thereto. The client PC 11 receives, for example, a HTML file as a HTTP response, and the HTML file is displayed on a screen by a function of a Web browser 111 installed into the client PC 11.

The Web server 12 is composed of a GUI processing section 121, an architecture conversion section 122 and a business logic section 123, as shown in FIG. 1. The GUI processing section 121 includes a Web-GUI definition composed of a HTML tag to designate display methods or the like of a text when viewing the HTML file through the Web browser 111, a prepared Web-based GUI component which represented by tag and so forth. The Web-based GUI component which represented by tag corresponds to a GUI definition (codes composing a variety of GUI components such as a text box, a radio button and the like in a form) contained in the conventional client application program.

The business logic section 123 corresponds to such a portion contained in the conventional client application program that performs an event processing or the like and is composed of one or more application(s) to execute an event processing in response to the request from the client PC 11.

The architecture conversion section 122 is arranged between the GUI processing section 121 and the business logic section 123 to realize a function of a Web application as a whole Web server 12 while assuring the structure of a business logic of the conventional client application program to thereby serve as an absorber of the difference between the architectures of the client/server system and the Web application system.

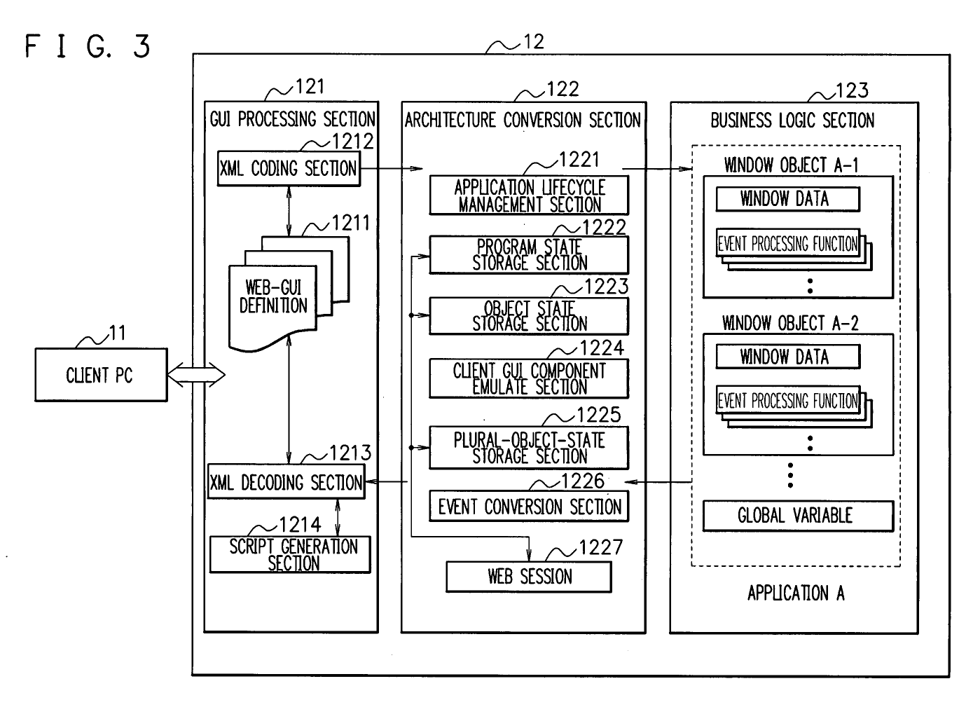

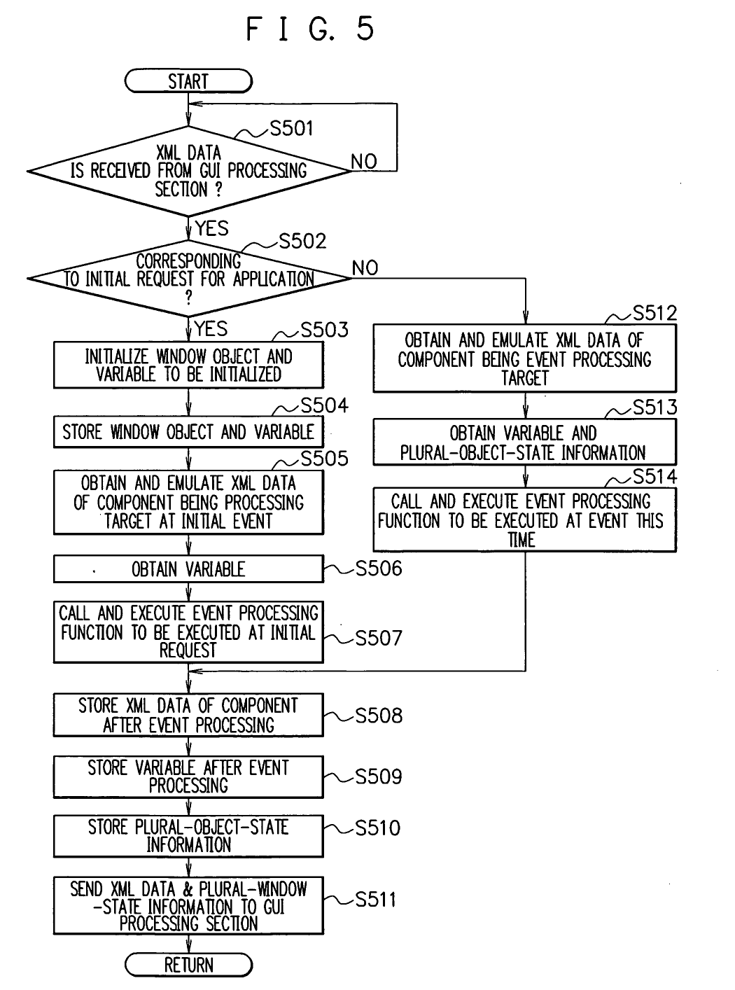

FIG. 2 is a view showing a hardware structure of the Web server 12. A CPU 201 comprehensively controls respective devices and controllers connected to a system bus. In a ROM 203 or an external memory 207, a BIOS (Basic Input/Output System) being a control program of the CPU 201, an operating system program, programs to be executed by the Web server 12 and, for example, of the processing shown in FIG. 4 to FIG. 6, and so forth are recorded. Note that, in the example in FIG. 2, although the external memory 207 is arranged outside the Web server 12, a structure in which a component corresponding to the external memory 207 is arranged in the Web server 12 is also acceptable as another embodiment. Further, as another structure, the program according to the present embodiment and to perform the processing shown, for example, in FIG. 4 to FIG. 6 may be recorded in a computer-readable recording media such as a CD-ROM, a flexible disk or the like to be supplied from the recording media, or otherwise the program may be supplied via a communication media such as the Internet.

A RAM 202 serves as a main memory, a work area and the like of the CPU 201. The CPU 201 realizes various operations by loading the program or the like required to execute the processing into the RAM 202 and by executing the program.

A memory controller 206 controls an access to an external memory 207 of a hard disk (HD), the flexible disk and the like. A communication I/F controller 205 is to connect and communicate with the client PC via the Internet, allowing communication over the Internet using TCP/IP and the like.

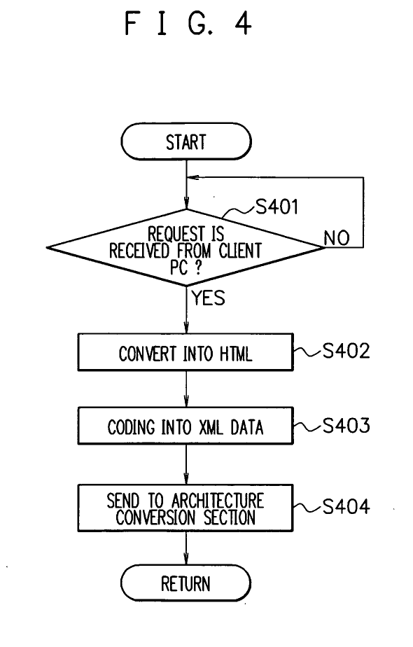

FIG. 3 is a view showing a functional structure of the Web server 12. As shown in FIG. 3, the GUI processing section 121 of the Web server 12 is composed of a Web-GUI definition 1211, an XML coding section 1212, an XML decoding section 1213, and a script generation section 1214.

The Web-GUI definition 1211 corresponds to the GUI definition contained in the conventional client application program, as described above.

The XML coding section 1212 generates a window object corresponding to an event request from the client PC 11 based on the Web-GUI definition 1211 to give the generated window object to the architecture conversion section 122 by coding it into XML data. In the present embodiment, in order to prescribe arrangement layout structure and data structure of a GUI component or the like in the window object, the window object depending on the architecture of a product mounted on the GUI processing section 121 is converted into a generalized window object (HTML). Note that the window object stated here is data to compose a window displayed on a Web browser.

The XML decoding section 1213 generates the window object (HTML data), which depends on the architecture of the product mounted on the GUI processing section 121, based on the generalized XML data given by the architecture conversion section 122 and the Web-GUI definition 1211 to transmit it to the client PC 11.

The script generation section 1214 generates a script as required. The generated script is transmitted to the client PC 11 together with the window object (HTML data) generated by the XML decoding section 1213.

The architecture conversion section 122 includes an application lifecycle management section 1221, a program state storage section 1222, an object state storage section 1223, a client GUI component emulate section 1224, a plural-object-state storage section 1225, an event conversion section 1226 and a Web session 1227.

The application lifecycle management section 1221 recognizes an execution section of the application (for example, an execution section of a Windows(registered trademark) OS) at an initial request to thereby initialize the window object and global variable inherent to the applicable application (business logic section 123), and performs an deleting request to later-described respective state storage sections at a timing when the entire application ends (for example, when a specific event to end the application occurs, when all the windows of the application are closed, or the like).

The program state storage section 1222 stores the current states of the window object and the global variable in the Web session 1227 when an event processing occurs in the business logic section 123. For instance, when the event corresponding to the initial request is processed, the initialized window object, the similarly initialized global variable, and the like are stored in the Web session 1227, and at a second event processing and thereafter with respect to the same application, the global variable and the like updated by the event processing is stored in the Web session 1227. Note that the Web session 1227 is a partial memory area, for example, in the RAM 202 provided to maintain the window object, the global variable and the like for each application.

The object state storage section 1223 stores the window object, for example, of the XML data or the like including the GUI component to which the processing result by the business logic section 123 is reflected in the Web session 1227.

The client GUI component emulate section 1224 converts the XML data corresponding to the respective GUI components in the window object into a class compatible with the business logic section 123 in order to make the XML data be the data that the business logic section 123 can handle.

The plural-object-state storage section 1225 generates plural-object-state information indicating current display states of plural windows such as occurrence (load)/erasing of an object, displayed/nondisplayed, focused/unfocused, presence/absence of a modal window (an object allowing no input with respect to a certain object when no input is made in advance to another object), and the like to thereby store them in the Web session 1227. The script generation section 1214 generates the script based on the plural-object-state information. With the generated script operating on the Web browser 111, the occurrence (load)/deleting of the object, display/nondisplay and the like can be placed under control.

The event conversion section 1226 recognizes the event occurred based on the operation on the Web browser 111 to call a corresponding event processing function from the business logic section 123.

The business logic section 123 is composed of the applications corresponding to the business logics of the conventional client application programs, as described above, and maintains window data composed of the global variables and the like used for each window and various event processing functions, for each window object specific to the business logic section 123, and, at the same time, maintains global variables used between the window objects. Further, these window objects and the global variables specific to the business logic section 123 are stored in the same sections as of the application.

Note that the XML coding section 1212, the XML decoding section 1213, the script generation section 1214, the application lifecycle management section 1221, the program state storage section 1222, the object state storage section 1223, the client GUI component emulate section 1224, the plural-object-state storage section 1225 and the event conversion section 1226 are recorded, for example, in the external memory 207, respectively, and are composed to correspond to the programs loaded as required to the RAM 202 and the CPU 201 executing the programs; the Web session 1227 is, for example, the partial memory area of the RAM 202; and the Web-GUI definition 1211 and the event processing function are data recorded for example in the external memory 207 or the ROM 203.

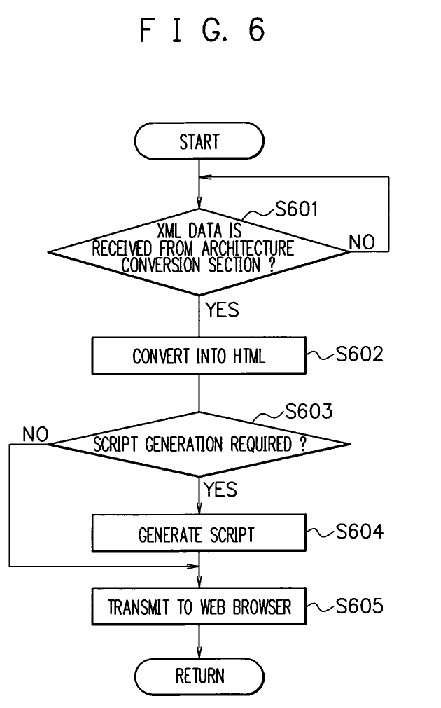

Subsequently, the description will be given of the operation of the Web server 12 with reference to the flowcharts in FIG. 4 to FIG. 6. FIG. 4 to FIG. 6 are flowcharts showing processing operations of the GUI processing section 121 and FIG. 5 is a flowchart showing the operation of the architecture conversion section 122.

In FIG. 4, when the XML coding section 1212 receives an event (for example, a request to activate an application, a request to return processing result, a request to end an application and so on) with respect to an application (hereinafter referred to as the “application A”) as an HTTP request from the client PC 11 (Step S401/YES), the XML coding section 1212 generates all the window objects contained in the application A in the form of the HTML data using the Web-GUI definition 1211 (Step S402). For instance, when the application A contains a window object A-1 and a window object A-2, then the window object A-1 and the window object A-2 are generated in the form of the HTML data. Hereinafter, the description will be given on the assumption that the application A contains the window object A-1 and the window object A-2.

Subsequently, the XML coding section 1212 encodes the generated window objects (HTML data) to XML data (step S403) to send the data to the architecture conversion section 122 (step S404). Note that when no event request is made from the client PC 11 (step S401/NO), the state turns into a standby state until the event request is received.

Subsequently, in FIG. 5, when the application lifecycle management section 1221 receives the XML data from the GUI processing section 121 (step S501/YES), the application lifecycle management section 1221 determines whether or not the event corresponds to the initial request with respect to the application A (step S502). This determination of determining whether or not it corresponds to the initial request is made based on whether or not the Web session 1227 maintains the window object and global variable contained in the application A. For instance, the application A contains the window object A-1, the window object A-2 and the global variable used by the application A, and when the Web session 1227 already stores the window object A-1, the window object A-2 and the global variable of the application A, then it is determined that the event of this time is not the initial request, while when the Web session 1227 does not store these with respect the application A, then it is determined that the event of this time is the initial request. Note that during the time period when no XML data is received from the GUI processing section 121 (step S501/NO), the state turns into the standby state until the XML data is received.

For instance, when the event occurred this time is determined to be the initial request (step S502/YES), the application lifecycle management section 1221 executes the initialization of all the window objects (the window object A-1 and the window object A-2) composing the application A specific to the business logic section 123 and the global variable of the application A (step S503).

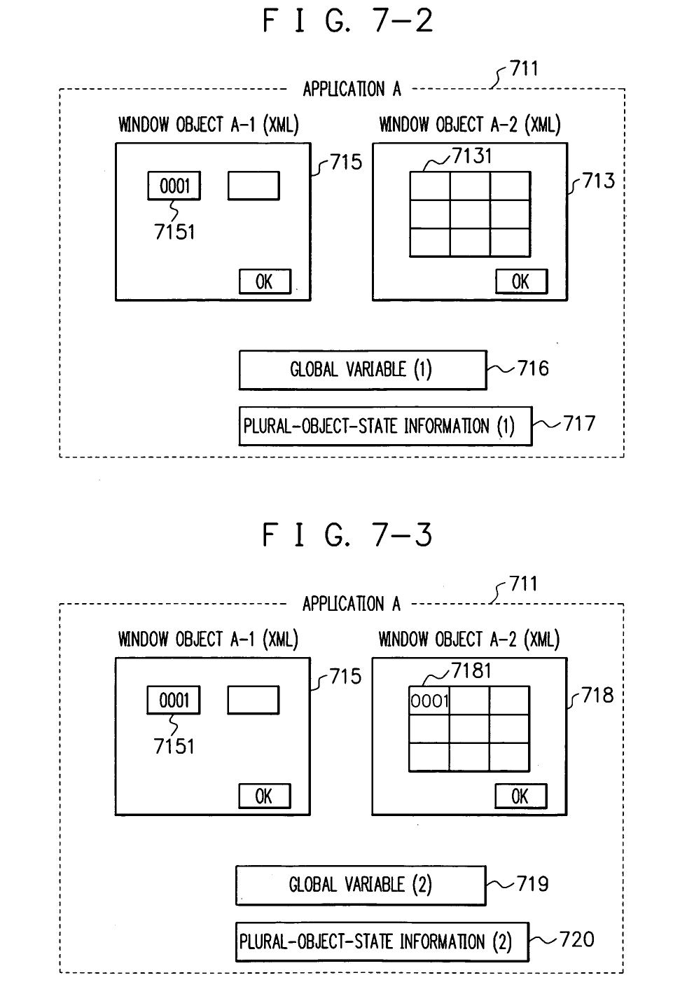

Subsequently, the program state storage section 1222 stores the initialized window objects A-1, A-2 and the global variable in the Web session 1227 (step S504). The stored state of the data in the Web session 1227 is schematically shown in FIG. 7-1. “711” in FIG. 7-1 denotes such a memory area in the Web session 1227 that is appropriated to the application A. “712” denotes the initialized window object A-1, “713” denotes the initialized window object A-2 and “714” denotes the initialized global variable. Note that the window objects A-1, A-2 are stored in the Web session 1227 in the form, for example, of the XML data. In the present embodiment, in step S504, the window object specific to the business logic section 123 is designed to be stored in the Web session 1227, however, it is possible to store a generalized window object in the initialized state which is generated by the GUI processing section 121 as another embodiment. However, since this generalized window object does not contain the event processing function, it is required that the event processing function specific to the business logic section 123 be initialized and stored in the Web session 1227.

Subsequently, the client GUI component emulate section 1224 acquires the XML data corresponding to the GUI component being a processing target of the business logic section 123 at the time of the initial request from the stored and already initialized window objects A-1 (712), A-2 (713), and converts the acquired XML data into a class compatible with the business logic section 123 (step S505). For instance, the GUI component that the business logic section 123 requires at the time of the initial request is a text box 1 of the window object A-1, and when the text box 1 is defined as “text1” in the XML data, then the applicable XML data part “text⇄ (“7121” in FIG. 7-1) of the window object A-1 is acquired and then the class thereof is converted into “textbox1” being a form that the business logic section 123 can handle.

Subsequently, the program state storage section 1222 acquires a global variable 714 of the application A from the Web session 1227 (step S506).

Subsequently, the event conversion section 1226 recognizes all the event processing functions that have to be executed at the time of the initial request, calls the applicable event processing functions sequentially from the business logic section 123, and executes them (step S507). With this, the processing result by the event processing functions is reflected to the XML data of which class is converted by the client GUI component emulate section 1224. For instance, when “0001” is assigned in the text box 1 by the event processing function at the time of the initial request, the “0001” is reflected to the XML data.

Subsequently, the object state storage section 1223 stores the XML data to which the processing result by the event processing function is reflected in the Web session 1227 (step S508). With the XML data stored here, the already stored initialized window object A-1 (XML data) is updated. Accordingly, in the Web session 1227, the current window object (XML data) A-1 after the event processing of this time is stored.

Subsequently, the program state storage section 1222 stores the global variable which is updated by the processing result by the event processing function of this time in the Web session 1227 (step S509).

Subsequently, the plural-object-state storage section 1225 generates the plural-object-state information indicating the display states of the plural window such as the window started do be displayed by the event processing of the initial request, the window become the focused target, as required, and stores them in the Web session 1227 (step S510). FIG. 7-2 schematically shows the stored state of the data in the Web session 1227 at this time. 715 in FIG. 7-2 denotes the updated window object A-1, “7151” denotes the XML data corresponding to the GUI component to which the processing result by the event processing function of this time is reflected, “716” denotes the global variable updated by the processing result by the event processing function of this time and “717” denotes the plural-object-state information stored when generated as required.

Subsequently, the architecture conversion section 122 sends the window objects A-1 (715), A-2 (713) to be stored in the Web session 1227 to the GUI processing section 121 (together with the plural-object-state information (717) when the plural-object-state information is generated by the plural-object-state storage section 1225) (step S511).

Meanwhile, when it is determined that the event occurred this time is not the initial request, namely when it is determined that a second event or thereafter is received with respect to the same application (step S501/NO), the client GUI component emulate section 1224 acquires the XML data corresponding to the GUI component being the processing target of the business logic section 123 at the event processing of this time from the window objects A-1, A-2 stored in the Web session 1227. Here, operations will be described concretely on the assumption that the event received this time is the second event with respect to the application A and, in the event processing corresponding thereto, the XML data corresponding to the GUI component being the processing target of the business logic section 123 are “7151”, “7131” in FIG. 7-2.

Subsequently, the client GUI component emulate section 1224 converts the acquired XML data 7151, 7131 into a class compatible with the business logic section 123 (step S512).

Subsequently, the program state storage section 1222 and the plural-object-state storage section 1225 acquire the applicable global variable 716 and the plural-object-state information 717 of the application A from the Web session 1227, respectively (step S 513).

Subsequently, the event conversion section 1226 recognizes all the event processing functions that have to be executed at the event of this time, calls the applicable event processing functions sequentially from the business logic section 123, and executes them (step S514). With this, the processing result by the event processing functions read out this time is reflected to the XML data 7151, 7131 emulated in step S512. For instance, in response to the event request of this time, when a processing such as a copying of “0001”, which is reflected to a component of the window object A-1 at the time of the initial request, onto a component of the window object A-2 is performed, then the XML data 7151 is not updated, however, the XML data 7131 is updated to be the data onto which the “0001” is copied.

Subsequently, the object state storage section 1223 stores the XML data, to which the processing result by the event processing function is reflected, in the Web session 1227 (step S508). In the case of the above-described example, the window object A-2 already stored is updated by the XML data stored here.

Subsequently, the program state storage section 1222 stores the global variable which is updated by the processing result by the event processing function of this time in the Web session 1227 (step S509).

Subsequently, the plural-object-state storage section 1225 generates the plural-object-state information indicating the display states of plural windows such as the window displayed by the event processing corresponding to the event of this time, the window become the focused target, as required, and stores them in the Web session 1227 (step S510). FIG. 7-3 schematically shows the stored state of the data in the Web session 1227 at this time. “718” in FIG. 7-3 denotes the updated window object A-2, “7181” denotes the XML data corresponding to the GUI component to which the processing result by the event processing function of this time is reflected, “719” denotes the global variable updated by the processing result by the event processing function of this time and “720” denotes the object-state information stored (updated) when generated as required.

Subsequently, the architecture conversion section 122 sends the window objects A-1 (715), A-2 (718) to be stored in the Web session 1227 to the GUI processing section 121 (together with the plural-object-state information 720 when the plural-object-state information is generated by the plural-object-state storage section 1225) (step S511).

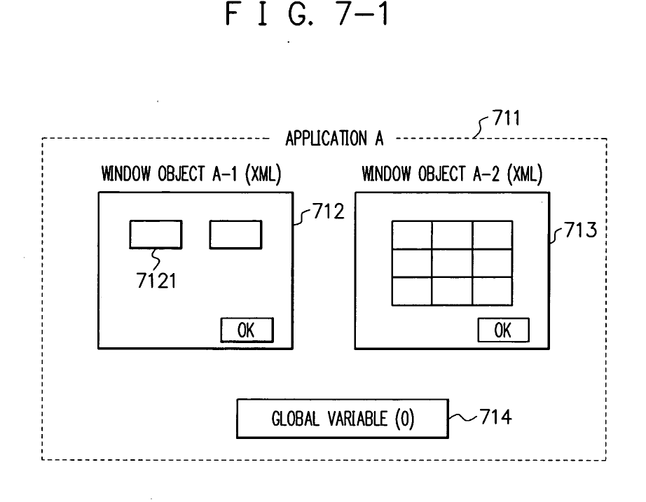

In FIG. 6, when the XML decoding section 1213 received the XML data (window object) from the architecture conversion section 122 (step S601/YES), the XML decoding section 1213 generates the window objects (HTML data) A-1, A-2 based on the received XML data and the Web-GUI definition 1211 (step S602). Note that during the time period when no XML data is received from the architecture conversion section 122 (step S601/NO), the state turns into the standby state until the XML data is received.

Subsequently, the script generation section 1214 determines whether or not the script is needed to be generated (step S603). When the XML decoding section 1213 receives the XML data together with the plural-object-state information, it is determined that the script is needed to be generated based on the plural-object-state information (step S603/YES), while when the XML decoding section 1213 receives the XML data only, it is determined that the script is not needed to be generated (step S603/NO).

When it is determined that the script is needed to be generated in step S603, the script generation section 1214 generates the script based on the plural-object-state information (step S604). Meanwhile, in step S603, when it is determined that the script generation is not necessary, the script is not generated.

For instance, when such the plural-object-state information that displays only a window A-1 corresponding to the window object A-1 where only the window A-1 corresponding to the window object A-1 is focused is generated, the script to display only the window A-1 to be focused on the Web browser 111 is generated.

Further, for instance, when the object-state information that the window A-1 and a window A-2 are displayed in which the window A-2 is focused is generated by the second processing or thereafter, the script to display the windows A-1, A-2 together, and also to operate such that the window A-2 is focused on the Web browser 111 is generated.

Subsequently, when the script is generated, the GUI processing section 121 sends the window object (HTML data) depending on the architecture of the product mounted on the GUI processing section 121 together with the script to the client PC 11, and when the script is not generated, the GUI processing section 121 sends only the window object (HTML data) to the client PC 11 (step S605).

On the client PC 11 side, the windows A-1, A-2 are displayed by the Web browser 111 based on the window objects A-1, A-2 received from the Web server 12. When the script is received together, the Web browser 111 displays the windows A-1, A-2 based on the script.

Note that, in FIG. 7-1 to FIG. 7-3, only the stored state of the data in the memory area appropriated to the application A is shown, however, beyond question, the Web session 1227 has corresponding memory areas to plural applications. Further, at the timing when the above-described application entirely ends, the data related to the application and stored in the Web session 1227 by the respective storage section 1222, 1223, 1224 are deleted.

As described above, in the present embodiment, it is composed that, after the event processing in response to the event request information applicable to the application A is executed, the states of the window object and the global variable which should be contained in the application A are stored, and when further event request information is received with respect to the application A, then the stored window object and global variable are used to perform the corresponding event processing, and that the window object after the event processing is sent to the external device. Accordingly, the function of the GUI application, which has been provided by the conventional client application, can be realized by a Web application while the function corresponding to the program state storage function of the conventional client application can be performed.

Further, in the present embodiment, it is composed that the script is generated based on the object state information indicating the display state of the window object to be sent to the client PC 11 together with the window object. Accordingly, with the script, the operations such as to display/nondisplay of the window, to focus a window and the like can be performed on the Web browser 111.

Furthermore, in the present embodiment, it is composed that the part of the window object corresponding to the event processing is converted into the data executable by the event processing function contained in the conventional client application. Accordingly, the business logic of the conventionally-provided client application can be used in the business logic section 123 of the Web server 12 without the need of changing the structure.

Note that, in the above, only the event processing in which the data “0001” 1is copied from a GUI component of the window object A-1 onto a GUI component of the window object A-2 is cited as an example, whereas the event processing that can be processed in the present embodiment is not limited thereto. In other words, needless to add, the event processing (for example, check boxes to select plural items, a button used to execute a function or to confirm a process, a radio button used to select only one item from plural items and the like) that a general GUI application can process is executable.

According to the present invention, it is composed that, after an event processing in response to an event request information applicable to a certain application program is performed, the states of a window object and a variable which should be contained in the application program are stored, and when an event request information with respect to the application program is further received, a corresponding event processing is performed using the stored window object and variable and further the window object after the processing is transmitted to an external device, in which, for example, a function corresponding to a program state storage function of a conventional client application can be performed, so that a GUI application function provided by the conventional client application can be realized by a Web application.

Further, according to another characteristic of the present invention, it is composed that a script is generated based on a display state data of a window and transmitted to the external device together with the window object, so that a screen control on a Web browser installed in the external device, such as display/nondisplay of screens and focus controls of screens of plural windows, can be performed from the information processor side.

Further, according to still another characteristic of the present invention, it is composed that at least a part of the window object is converted into data executable by an event processing function contained in the conventional client application, so that, as an event processing unit, the conventionally-used client application and the like can be used without changing their structures.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. An information processor connected to an external device via a communication line, comprising:
a receiving unit receiving event request information from the external device;
an event processing unit executing an event processing which should be executed by an application program corresponding to a first event request information received by said receiving unit, with respect to at least one window object and a variable which should be contained in the application program applicable to the first event request information;
a storage unit storing the window object and the variable after the event processing performed by said event processing unit in a recording medium; and
a transmission unit transmitting the window object after the event processing performed by said event processing unit to the external device,
wherein said event processing unit executes an event processing corresponding to a second event request information using the window object and the variable stored in the recording medium when said receiving unit further receives the second request information applicable to the application program.

2. The information processor according to claim 1, further comprising:
a display state information generation unit generating a display state information showing a display state of the window object after the event processing corresponding to the first event request information; and
a script generation unit generating script information operating on a Web browser based on the display state information,
wherein said transmission unit transmits the script information to the external device.

3. The information processor according to claim 1, further comprising a conversion unit converting at least a part of the window object into data executable by an event processing function which should be contained in the application program,
wherein said event processing unit includes the event processing function and executes an event processing with the event processing function with respect to at least a part of the window object converted by said conversion unit.

4. The information processor according to claim 2, further comprising a conversion unit converting at least a part of the window object into data executable by an event processing function which should be contained in the application program,
wherein said event processing unit includes the event processing function and executes an event processing with the event processing function with respect to at least a part of the window object converted by said conversion unit.

5. An information processing method by an information processor connected to an external device via a communication line, comprising:
a step of receiving event request information from the external device;
an event processing step executing an event processing which should be executed by an application program corresponding to a first event request information received by the receiving unit, with respect to at least one window object and a variable which should be contained in the application program applicable to the first event request information;
a storing step storing the window object and the variable after the event processing performed by the event processing unit in a recording medium; and
a transmitting step transmitting the window object after the event processing performed by the event processing unit to the external device;
wherein the event processing step executes an event processing corresponding to a second event request information using the window object and the variable stored in the recording medium when the receiving unit further receives the second request information applicable to the application program.

6. A program product for causing a computer to execute an information processing method by an information processor connected to an external device via a communication line, the computer program product comprising:
a computer-readable program code means for executing a step of receiving event request information from the external device;
a computer-readable program code means for executing an event processing step executing an event processing which should be executed by an application program corresponding to a first event request information received by the receiving unit, with respect to at least one window object and a variable which should be contained in the application program applicable to the first event request information;
a computer-readable program code means for executing a storing step storing the window object and the variable after the event processing performed by the event processing unit in a recording medium; and
a computer-readable program code means for executing a transmitting step transmitting the window object after the event processing performed by the event processing unit to the external device;
wherein the event processing step executes an event processing corresponding to a second event request information using the window object and the variable stored in the recording medium when the receiving unit further receives the second request information applicable to the application program.
